(19) United States
(12) Patent Application Publication
(10) Pub. No.: US 2024/0035519 A1
(43) Pub. Date: Feb. 1, 2024

(54) TORSIONAL DAMPER

(71) Applicant: ZF Friedrichshafen AG, Friedrichshafen (DE)

(72) Inventors: Andreas ECK, Grettstadt (DE); Luc Jonckheere, Werneck (DE); Dominik Bühl, Eltmann (DE); Philipp Günster, Schlüsselfeld (DE); Edmont Hofmann, Niederwerrn (DE); Benedikt Kolb, Bad Neustadt (DE); Andreas Kubisch, Euerbach (DE); Tim Schindler, Bergtheim (DE); Fabian Liebst, Oberstreu (DE); Andreas Krönert, Donnersdorf (DE); Michael Bullinger, Werneck (DE); Andreas Gidt, Aura a. d. Saale (DE)

(73) Assignee: ZF Friedrichshafen AG, Friedrichshafen (DE)

(21) Appl. No.: 18/227,773

(22) Filed: Jul. 28, 2023

(30) Foreign Application Priority Data
Jul. 29, 2022 (DE) 102022207823.3

(51) Int. Cl. F16D 3/14; F16D 3/12

(52) U.S. Cl. CPC F16D 3/14; F16D 3/12; F16D 2300/22

(57) ABSTRACT

Torsional damper (34), with an input element (E), an output element (A), an elastic element (16), and a friction device (36). The input element (E) and the output element (A) are rotatable to a limited extent with respect to one another against a restoring force of the elastic element (16). The friction device (36) has a friction disk (24), a holding element (28) and a preloading element (26), wherein the holding element (28) is connected to the friction disk (24) for conjoint rotation therewith. The holding element (28) is connected to the output element (A) for conjoint rotation therewith. The holding element (28) is arranged axially between the friction disk (24) and the preloading element (26). A clutch disk having a torsional damper as described above is also disclosed.

### BACKGROUND OF THE INVENTION

### 1. Field of the Invention

The invention relates to a torsional damper in accordance with the preamble of patent claim 1 and to a clutch disk having a torsional damper of this kind.

### 2. Description of the Related Art

DE 10 2020 202 324 A1 relates to a friction device for a clutch disk. The friction device disclosed there comprises a friction ring, a holding plate and a diaphragm spring, which are formed jointly in a module that can be preassembled. On the one hand, the holding plate is fixedly connected to the friction ring, wherein the diaphragm spring is arranged axially between the holding plate and the friction disk. A friction device of this kind makes possible a defined wear location between the friction disk and the friction partners thereof, in particular the driver disk. This prevents wear at unwanted locations, such as the diaphragm spring, thereby providing a long life with a substantially unchanged friction power. Since the friction device module is under preload from the diaphragm spring, assembly is made more difficult. To ensure that the torsional damper is easy to assemble, preassembly of the friction device module is necessary.

### SUMMARY OF THE INVENTION

It is an object to provide a torsional damper having a friction device which ensures a long life with a defined wear location and is, in addition, easy to assemble.

This object is achieved by a torsional damper having
an input element, an output element, an elastic element, a friction device,
wherein the input element and the output element are designed to be rotatable to a limited extent with respect to one another against a restoring force of the elastic element,
wherein the friction device has a friction disk, a holding element and a preloading element,
wherein the holding element is connected to the friction disk for conjoint rotation therewith, and
wherein the holding element is connected to the output element for conjoint rotation therewith,
and the holding element is arranged axially between the friction disk and the preloading element.

A torsional damper of this kind and a clutch disk having a torsional damper of this kind are suitable for transmitting a driving torque of an internal combustion engine, particularly in a motor vehicle or truck.

A power transmitted via the torsional damper is introduced into the input element and is output via the output element. The input element is formed by means of a driver disk, for example. The output element is formed, for example, by side disks and an intermediate hub, which are fixedly connected to one another. As an option, an intermediate hub disk is also formed, which is fixedly connected to the side disks and the intermediate hub. The elastic element is formed by a helical compression spring, for example. It is advantageous if a helical compression spring is supported at its axial ends, via spring plates, relative to the input element and/or the output element. The spring plates allow pivotable activation of an elastic element. By way of example, a plurality of helical springs is arranged coaxially one inside the other. Helical springs with spring plates are also referred to as spring packs. It is advantageous if a plurality of elastic elements is distributed uniformly over the circumference.

The input element and the output element are arranged coaxially with one another and are designed to rotate relative to one another. The elastic element counteracts a relative rotation between the input element and the output element.

The friction disk is designed to dissipate energy via friction when there is a relative rotation between the input element and the output element. A driver disk of the torsional damper serves as a friction partner for the friction disk, for example. The preloading element imposes an axial preloading force on the friction disk. The preloading element is designed to impose the preloading force directly or indirectly on the friction disk. The preloading force acts from the friction disk toward the friction partner or friction surface. The holding element is connected to the output element for conjoint rotation therewith. Such a connection for conjoint rotation prevents a relative rotation between the preloading element and the output element as well as between the preloading element and the friction disk. The holding element is designed in such a way that a torsionally rigid connection is provided between the friction disk and the output element. The holding element is designed in such a way that the friction disk is designed to be axially movable, in particular axially movable with respect to the output element. The holding element is designed to be stiff in the circumferential direction and flexible in the axial direction. Stiffness in the circumferential direction and flexibility in the axial direction are provided, for example, by support arms which have a corresponding length and extend along an axial plane. Axial mobility is achieved by a sufficient length of the support arms, wherein the extent in the axial plane provides stiffness in the circumferential direction. The preloading element is advantageously designed as a diaphragm spring.

A connection for conjoint rotation between the holding element, which is fixedly connected to the friction disk, and the output element provides a defined friction surface between the friction disk and the friction partner thereof. The friction partner is advantageously a component of the input element.

The holding element is arranged axially between the friction disk and the preloading element. This is particularly advantageous in the assembly of the torsional damper. During a preassembly process, this makes it possible to connect only the friction disk and the holding element to one another. With such a design, it is alternatively also possible to dispense with full or partial preassembly of the friction device. In particular, it is possible to insert all the components during the assembly of the torsional damper. It is thereby possible to eliminate a large number of working steps.

Further advantageous design variants of a torsional damper of this kind are explained below.

It is advantageous if the preloading element is in abutting contact with the friction disk.

Direct power transmission between the preloading element and the friction disk is thereby provided. It is advantageous if the preloading element extends axially through the holding element. The preloading element is in direct abutting contact with the friction disk. An embodiment involving direct abutting contact between the preloading element and the friction disk allows preassembly between the holding element and the friction disk, despite the arrangement of the holding element between the friction disk and preloading element. A connection for conjoint rotation between the friction disk and the output element is thereby provided in a reliable manner. Moreover, the preloading element is no longer part of the preassembled module, thereby making preassembly of the module significantly easier owing to the absence of the preloading force of the preloading element.

In an advantageous design variant, the preloading element is designed to provide an axial preload on the friction disk and/or on the holding element.

This applies to all the types of friction device which are explained in this document, both friction devices which include preassembly in a module and those which do not. Depending on the design variant, the preloading element is in direct abutting contact with the friction disk or with the holding element. It is advantageous if the preloading element is, on the one hand, exclusively in abutting contact with the friction disk or exclusively in abutting contact with the holding element.

It is advantageous if the holding element is fixedly connected to the friction disk.

A fixed connection provides the rotationally secure connection between the holding element and the friction disk with a very high degree of reliability.

It is advantageous if the holding element and the friction disk are welded or riveted to one another.

These fastening methods provide a means of fastening the components to one another which is particularly simple to produce and particularly secure.

In a further design variant, the preloading element is in abutting contact with the holding element and provides an axial preload on the friction disk indirectly via the holding element.

The preloading element is preferably in direct abutting contact with the holding element. Such an embodiment is particularly advantageous in the case of a friction device without a preassembled module. In particular, a contact force between the holding element and the friction disk is provided, and these provide security against rotation by means of the rotational securing contours explained below.

It is advantageous if a rotational securing contour is formed on the friction ring, and a rotational securing contour is formed on the holding element, each of said contours corresponding to one another and providing a connection for conjoint rotation under axial preload.

Assembly of a torsional damper or of a clutch disk without a preassembled module is thereby provided, wherein relative rotation of the preloading element with respect to the adjacent component is prevented. The axial preloading is provided by the preloading element. The rotational securing contours advantageously engage axially in one another. The rotational securing contours are advantageously designed in such a way that they are centered one inside the other. The rotational securing contours are advantageously designed in such a way that one of the rotational securing contours allows axial engagement, while the other rotational securing contour engages axially. The axially engaging rotational securing contour advantageously has a fit or an oversize. Centering is thereby ensured. An undersize of the axially engaging rotational securing contour would allow complete entry into the other rotational securing contour, and there would be a residual relative mobility of the rotational securing contours with respect to one another. By way of example, a rotational securing contour is provided by a circular or spherical contour. Arranging a plurality of, for example, U-shaped contours in a row also represents an advantageous design variant. The engagement of the rotational securing contours in one another, together with the axial preload by the preloading element, provides a rotational securing device which ensures rotationally secure connection.

It is advantageous if the rotational securing contours on the friction ring and on the holding element are arranged radially on the outside and/or radially on the inside.

The preloading element is advantageously designed in such a way that it introduces the axial force at the radial level of the rotational securing contours. During assembly, a radially inner arrangement of the rotational securing contours enables centering of the preloading element on a radially inner component, in particular the intermediate hub or the hub. A radially outer arrangement of the rotational securing contours allows a higher holding force between the friction disk and the holding element.

It is advantageous if the rotational securing contour protrudes radially outward or radially inward from the holding element.

Radial protrusion beyond the holding element allows direct abutting contact between the preloading element and the rotational securing contour. This makes it possible to transmit the axial preloading force directly and exclusively to the rotational securing contour of the holding element. Accordingly, optimum introduction of the contact force to the rotational securing contours is provided, and rotational securing of the holding element and the friction disk relative to one another is ensured.

It is proposed that the preloading element should rest against the rotational securing contour, in particular exclusively against the rotational securing contour.

The preloading element rests against the rotational securing contour of the holding element. Such an embodiment can be formed both in the case of rotational securing contours which do not protrude radially and in the case of rotational securing contours which protrude radially. Optimum introduction of the contact force to the rotational securing contours is thereby provided, and rotational securing of the holding element and the friction disk relative to one another is ensured.

It is advantageous if the friction disk, the preloading element and/or the holding element are arranged in a centered manner on an intermediate hub or hub.

The centered components, that is to say the friction disk, the preloading element and/or the holding element, advantageously have corresponding radially inner sections, which are provided for contact, subject to radial play, with a radially outer surface of the intermediate hub. Simple assembly of the clutch disk or the torsional damper is thereby provided. The components can be inserted in a simple manner, and the torsional damper or the clutch disk can be closed by the mounting of a further component, in particular a side disk, and by riveting.

It is proposed that a fastening section of the holding element be formed with an axial offset.

It is thereby possible to dispense with the formation of an intermediate hub disk. The axial offset advantageously takes place between a base body of the holding element, which provides a fixed connection to the output element, and support arms of the holding element, which ensures circumferentially stiff and axially flexible connection of the friction disk. It is particularly advantageous if the base body of the holding element is formed circumferentially in a closed circle or circumferentially in segmental fashion, being formed by a plurality of segments which are adjacent in the circumferential direction. In an advantageous design variant, the holding element has lugs which engage in cutouts of the friction disk. The lugs and cutouts provide an assembly aid which ensures correct alignment between the holding element and the friction disk, in particular for the correct alignment of the rotational securing contours.

The above object is furthermore achieved by a clutch disk as claimed in claim 10.

Such a clutch disk comprises a torsional damper according to one or more of the preceding or following design variants or as claimed in any one of claims 1 to 9.

In addition to a torsional damper acting as a main damper, a clutch disk comprises, inter alia, friction linings, a friction lining carrier, a predamper and/or a hub.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The torsional damper and the clutch disk are explained in detail below by way of example with reference to a number of figures. More specifically:

FIG. 1 shows a first clutch disk comprising a torsional damper having a friction device in a perspective partial illustration;

FIG. 2 shows the friction device of the clutch disk from FIG. 1 in a separate illustration;

FIG. 3 shows an alternative friction device of the clutch disk of FIG. 1 in a separate illustration;

FIG. 4 shows the friction device from FIG. 2 in a further separate illustration;

FIG. 5 shows the friction device from FIG. 2 in a further separate illustration;

FIG. 6 shows a plurality of fastening possibilities between a friction disk and a holding element of the friction device;

FIG. 7 shows a schematic illustration of the installation situation of the friction device;

FIG. 8 shows a second clutch disk comprising a torsional damper having a friction device in a cross-sectional illustration;

FIG. 9 shows an enlarged illustration of the friction device from FIG. 8;

FIG. 10 shows a third clutch disk comprising a torsional damper having a friction device in a perspective partial illustration;

FIG. 11 shows the friction device of the clutch disk from FIG. 10;

FIG. 12 shows a fourth clutch disk comprising a torsional damper having a friction device in a perspective partial illustration;

FIG. 13 shows the friction device of the clutch disk from FIG. 12 in an exploded illustration;

FIG. 14 shows a further illustration of the friction device from FIG. 13; and

FIG. 15 shows a further illustration of the friction device from FIG. 14.

### DETAILED DESCRIPTION OF THE PRESENTLY PREFERRED EMBODIMENTS

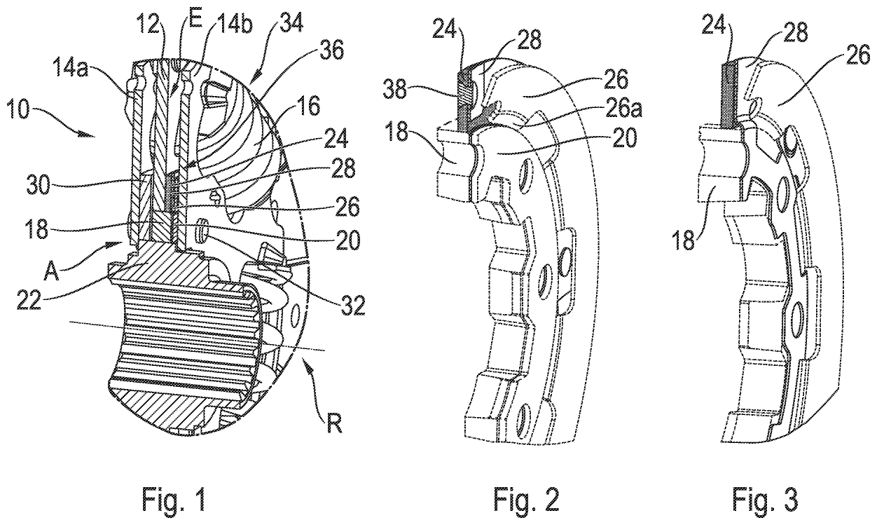

FIG. 1 shows a clutch disk 10 in a perspective illustration in section. The clutch disk comprises friction linings, a driver disk 12, side disks 14a and 14b, elastic elements 16, an intermediate hub 18, an intermediate hub disk 20, a hub 22, a friction disk 24, a preloading element 26, a holding element 28, a spacer disk 30 and rivets 32. The friction linings are fastened radially on the outside to the driver disk, in particular to a friction lining carrier, which is fixedly connected to the driver disk. A riveted-on friction lining carrier is indicated in FIG. 1, but the friction linings themselves are not shown.

The clutch disk 10 comprises a torsional damper 34. The torsional damper 34 forms a main damper of the clutch disk. The torsional damper likewise comprises a predamper, although this is not visible in the illustration shown. Moreover, the predamper is optional.

The torsional damper 34 comprises an input element E, which is formed by the driver disk, and an output element A, which comprises the side disks 14a and 14b, the intermediate hub 18 and the intermediate hub disk 20. The side disk 14a and 14b, the intermediate hub 18 and the intermediate hub disk 20 are fixedly connected to one another by a plurality of rivets 32. The input element E and the output element A are designed to be rotatable to a limited extent relative to one another about an axis of rotation R. The limitation of the relative rotation is provided by a stop between the input element E and the output element A. In an alternative embodiment, the elastic elements 16 form a block. The elastic elements 16 are arranged in a uniformly distributed manner over the circumference and are arranged on the driver disk 12 and the side disks 14a and 14b via spring plates. The elastic elements 16 produce a restoring force between the input element E and the output element A.

Furthermore, the torsional damper 34 comprises a friction device 36, which generates friction during a relative rotation between the input element E and the output element A and thereby dissipates energy absorbed by the torsional damper 34. The friction device 36 comprises the friction disk 24, the preloading element 26 and the holding element 28.

The preloading element 26 is formed by a diaphragm spring. The friction device 36 is shown separately and in detail in FIGS. 2, 4 and 5. The holding element 28 comprises a circular base body 28a. Radially on the inside, the circular base body 28a has toothing 28b, which corresponds to the outer toothing of the hub 22. The toothing between the hub and the intermediate hub provides the rotary stop for the predamper.

The holding element 28 furthermore has openings 28c, which enable the rivets 32 to pass through and the holding element 28 to be fastened to the output element. The holding element 28 is fastened to the output element A axially between the intermediate hub 18 and the intermediate hub disk 20.

Support arms 28d are formed radially on the outside of the base body 28a. The support arms 28d are of U-shaped design. Such a support arm 28d extends radially outward starting from the base body 28a and merges into a section extending in the circumferential direction, which subsequently merges into a section extending radially inward, which opens out at the base body 28a. The support arm 28d begins and ends at an opening 28c, wherein the support arm 28d extends over a further opening 28c in the circumferential direction. A sufficient length is thereby provided for the support arm 28d. By virtue of the design, in particular the provided length of the support arm 28d, an axial flexibility of the support arm 28d is provided, while, at the same time, said arm is of stiff design in the circumferential direction. A plurality of support arms 28d, distributed in the circumferential direction, is formed on the holding element 28, there being five of said arms in this exemplary embodiment.

In a central region of a support arm 28d, an opening 28e is formed which serves for fastening the friction disk 24 with the aid of a rivet 38. Openings 24b are furthermore formed in the friction disk 24, said openings serving to allow the rivets 38 to pass through. By means of rivets 38, the friction disk 24 is fixedly connected to the holding element 28. The friction disk 24 is thus connected to the holding element 28 for conjoint rotation in the circumferential direction and, by virtue of the support arms 38, is designed to be axially movable with respect to the holding element 28.

The friction disk 24 is of circular design and, in the radially inner region, has contact sections 24a, which extend in the radial direction. The contact sections 24a extend radially inward and serve, inter alia, for abutting contact with the preloading element 26. The preloading element 26 is formed by a diaphragm spring 26 which has contact sections 26a in the radially inner region. Starting from a base body, the contact sections 26a extend radially inward and are provided for direct abutting contact with the contact sections 24a of the friction disk 24.

The contact sections 26a are distributed uniformly in the circumferential direction. The contact sections 26a reach axially through the holding element 28, in particular radially between the base body 28a and the support arm 28b. The contact sections 26a are angled axially toward the friction disk 24. The axial preloading force of the preloading element 26 acts directly on the friction disk 24.

The holding element 28 is arranged axially between the preloading element 26 and the friction disk 24. The preloading element 26 thus rests axially against the friction disk 24, on the one hand, and axially against the side disk 14b, on the other hand. The side disk 14b and the friction disk 24 are connected to one another for conjoint rotation. Relative rotation in the circumferential direction between the preloading element 26 and an adjacent component is thereby prevented. Wear occurs in a defined manner exclusively between the friction disk 24 and the driver disk 12. This prevents wear on the preloading element 26 or a contact partner of the preloading element 26, thereby providing a substantially constant contact force on the friction disk 24 over the entire service life.

During assembly, only the friction disk 24 and the holding element 28 are preassembled in a module. This eliminates preassembly with preloading of the preloading element 26, thereby significantly simplifying the assembly process. During the assembly of the clutch disk, the preloading element 26 is merely inserted.

The contact sections 26a of the preloading element 28 and also the contact sections 24a of the friction disk enable simple radial centering on the intermediate hub 18 and the intermediate hub disk 20 during assembly.

FIG. 3 shows an alternative design variant of the friction device 36 to FIG. 2. In this case, an axial offset is formed between the base body and the support arms. It is thereby possible to eliminate the embodiment of an intermediate hub disk.

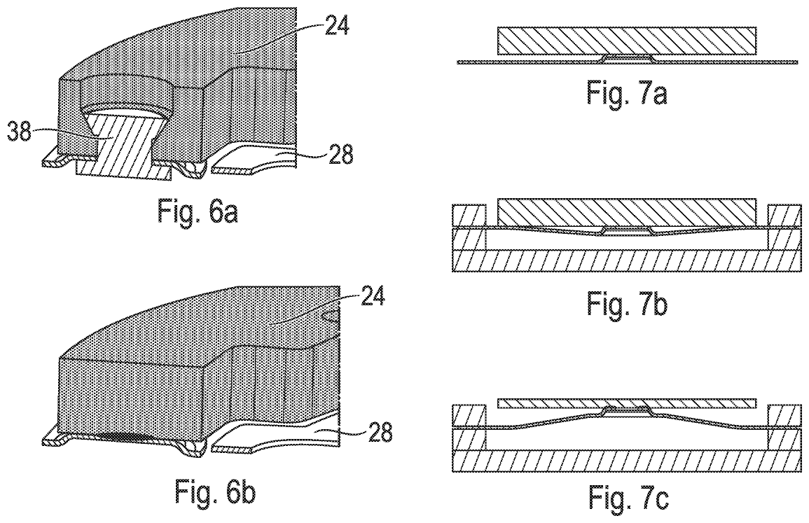

FIG. 6a illustrates fastening of the friction disk 24 to the holding element 28 by means of the rivet 38. In an alternative design variant according to FIG. 6b, the friction disk 24 and the holding element 28 are welded to one another. In this case, the friction disk 24 can be of axially thinner design. In addition, corresponding production steps for providing the openings and for riveting the components are eliminated. The production process is thereby further simplified.

FIGS. 7a to 7c show a simplified illustration of the state of the holding element and the friction disk as a module. FIG. 7a shows the initial state of the module consisting of the friction disk 24 and the holding element 28. FIG. 7b illustrates the new state after assembly. Here, the support arm is deflected axially away from the driver disk. FIG. 7c illustrates the state in the case of wear. Here, the support arm is deflected axially toward the driver disk. The axial deflection is effected by the axial preload of the preloading element 26, which is not illustrated in FIG. 7.

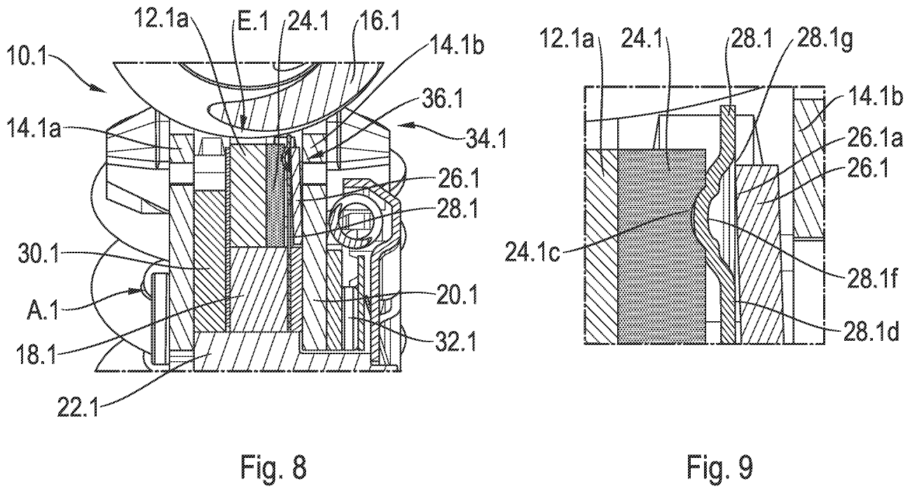

An additional clutch disk 10.1 is illustrated in FIGS. 8 and 9. The above statements apply correspondingly. The reference signs for the various components are taken over with the suffix X.1. The construction and operation of the clutch disk, the torsional damper and the friction device are largely identical with the clutch disk shown in FIG. 1. The differences are explained in detail below.

The axial arrangement of the components of the friction device 36.1 is unchanged. The holding element 28.1 is arranged axially between the friction disk 24.1 and the preloading element 26.1. The preloading element 26.1 is designed as a diaphragm spring. The holding element 28.1 is fastened axially between the intermediate hub 18.1 and the intermediate hub disk 20.1 by means of the rivets 32.1.

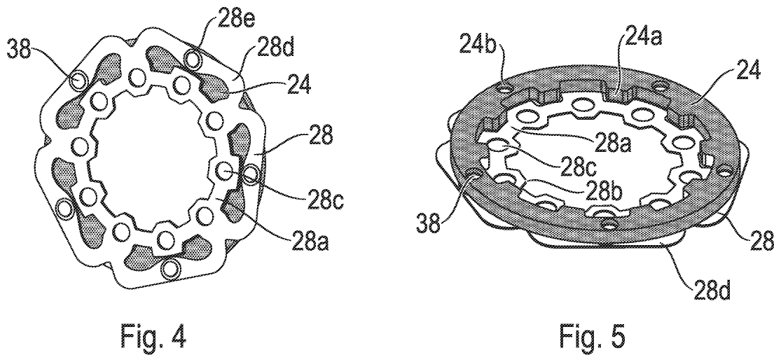

The friction disk 24.1 and the holding element 28.1 are of substantially identical design to the friction disk 24 and the holding element 28 shown in FIGS. 4 and 5. There is no fastening between the friction disk 24.1 and the holding element 28.1. The friction disk 24.1 forms a rotational securing contour 24.1c, which interacts with a rotational securing contour 28.1f of the holding element 28.1. The rotational securing contours 24.1c and 28.1f correspond to one another and engage axially in one another. Owing to the axial contact force of the preloading element 26.1, the rotational securing contours 24.1c and 28.1f are preloaded axially toward one another. The preloading element is designed in such a way that it provides an axial force on the holding element 28.1 in the radial region of the rotational securing contours 24.1c and 28.1f. The preloading element is thus in direct abutting contact with the holding element 28.1. The friction disk 24.1 is preloaded axially with respect to the driver disk 12.1a indirectly via the holding element 28.1.

The preloading element 26.1 rests by means of its radially outer region against the holding element and by means of its radially inner region against the side disk 14.1b. The preloading element 26 shown in FIGS. 2 and 3 is of inverted design.

The rotational securing contour 24.1c is formed by a trough or recess. In cross section, the rotational securing contour 24.1c is formed by a substantially circular recess. The rotational securing contour 28.1f is formed by a shaped feature of the holding element 28.1, which is in the form of sheet metal. The shaped feature is formed, in particular, in the support arm of the holding element 28.1. In cross section, the shaped feature is likewise of substantially circular design. The extent of the shaped feature of the holding element 28.1 is greater than that of the recess of the friction disk 24.1. This provides centering of the rotational securing contours with respect to one another, thereby providing a defined relative alignment of the components with respect to one another. In principle, the shaped feature and the recess may also take shapes other than the circular or spherical.

In the case of such a construction, preassembly of a preassembled module is eliminated. In particular, the components of the friction device can be inserted directly during the assembly of the clutch disk and of the torsional damper.

In this embodiment, the contact section 26.1a of the preloading element 26.1 interacts with the contact section 28.1g of the holding element 28.1. The contact sections 26.1a and 28.1g are in mutual abutting contact.

As can be seen in FIG. 8, the clutch disk has a further torsional damper in the form of a predamper.

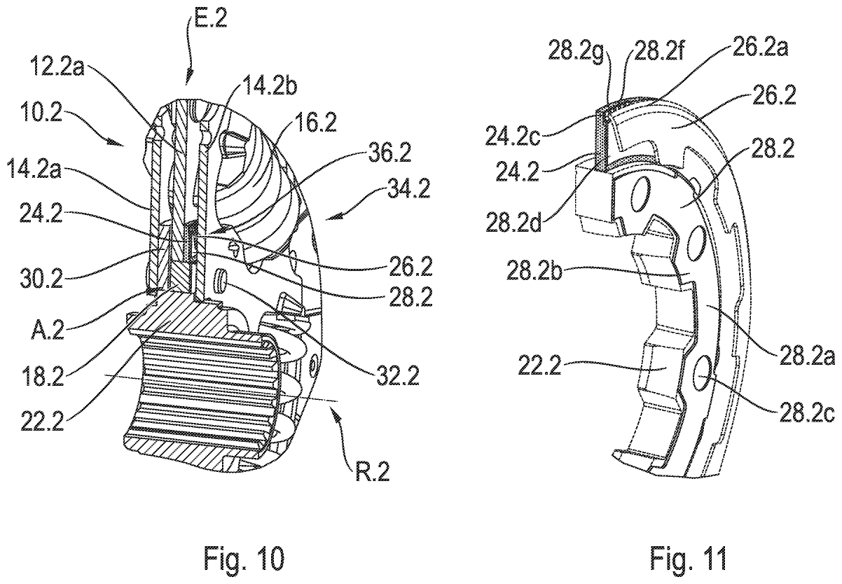

FIGS. 10 and 11 show a third clutch disk 10.2 having a further friction device 36.2. Clutch disk 10.2 corresponds substantially in construction and operation to the clutch disks described above. The above statements apply correspondingly, and only the differences are explained in detail below. The reference signs for the various components are taken over with the suffix X.2. Friction device 36.2 represents a further development of friction device 36.1.

In FIG. 11, it can be seen that the rotational securing contour is formed by a series of a plurality of depressions on the circumference. The rotational securing contours 24.2c and 28.2f engage in one another with a fit. A depression has a plurality of adjacently arranged U-shaped contours. Such a structure is illustrated by means of a further exemplary embodiment particularly in FIGS. 13 and 15, and can be seen more easily there. The rotational securing contour 24.2c is formed on the friction disk 24.2 in the form of a recess, wherein the rotational securing contour 28.2f is formed on the holding element in the form of a stamped feature. A plurality of similar pairs of corresponding rotational securing contours is formed over the circumference, providing an arrangement for conjoint rotation between the friction disk 24.2 and the holding element 28.2. The security against rotation is ensured by the axial preload of the preloading element 26.2 on the holding element.

The rotational securing contour 28.2f extends radially outward on the holding element 28.2, starting from a support arm 28.2d. The rotational securing contour 28.2f thus extends radially outward beyond the support arm 28.2d. The preloading element 26.2 in the form of a diaphragm spring has a contact section 26.2a, which interacts with the contact section 28.2g of the holding element. The contact section 26.2a is formed radially on the outside of the preloading element, wherein the contact section is angled axially toward the holding element 28.2. The contact section 28.2g of the holding element is formed by the rotational securing contour 28.2f. This ensures that the preloading element 26.2 provides the entire axial preloading force on the rotational securing contours 28.2f. The preloading force also acts indirectly on the friction disk.

By means of such a construction, rotationally secure fastening is further improved by selective introduction of force and optimized rotational securing contours.

Furthermore, an intermediate hub disk is eliminated. Starting from the base body 28.2a of the holding element, the support arm initially extends in the axial direction. Accordingly, the support arm extends in the axial direction along a radially outer surface of the intermediate hub 22.2. Subsequently, the support arm 28.2c extends in the radial direction and forms the known shape. An axial offset between the base body 28.2a and the support arm 28.2c is thereby bridged.

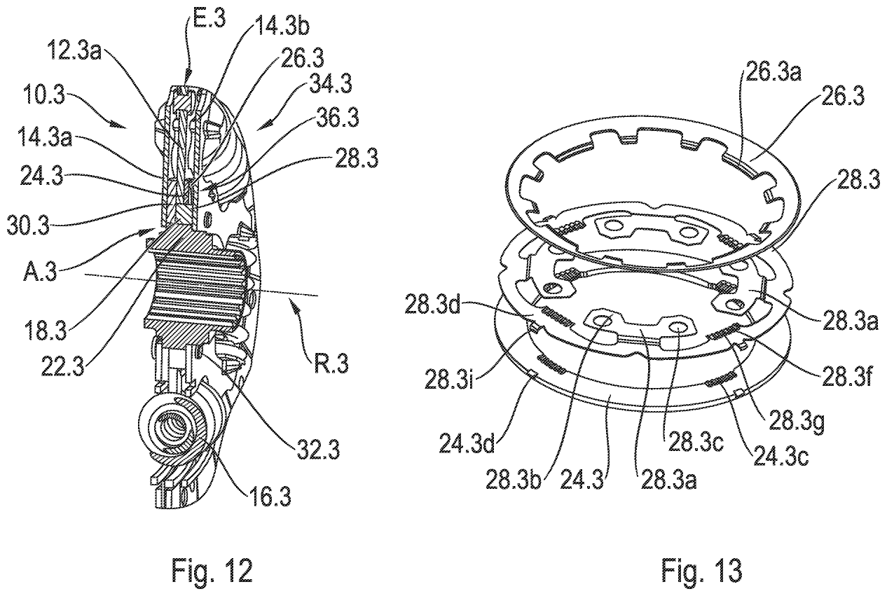

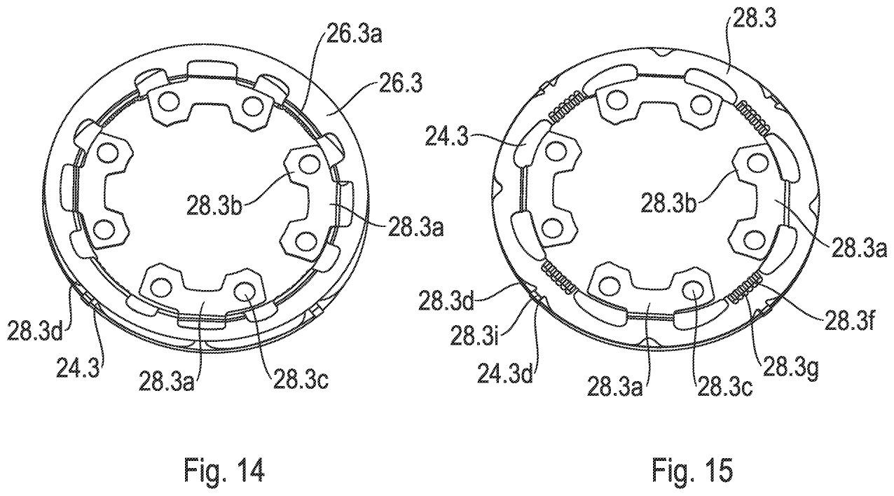

FIG. 12 illustrates a further clutch disk 10.3. The friction device 36.3 is illustrated in detail in FIGS. 13 to 15. Clutch disk 10.3 corresponds substantially in construction and operation to the clutch disks described above. The above statements apply correspondingly, and only the differences are explained in detail below. The reference signs for the various components are taken over with the suffix X.3. Friction device 36.3 represents a further development of friction device 36.2.

The rotational securing contours 24.3c and 28.3f are formed radially on the inside of the friction disk 24.3 and on the support arm 28.3d of the holding element 28.3. In addition, the rotational securing contour 28.3f simultaneously forms the contact section 28.3f, which interacts with the contact section 26.3a of the preloading element 26.3. The contact section 26.3a is formed radially on the inside of the preloading element 26.3. In particular, the contact section 26.3a is angled in the axial direction toward the holding element 28.3. The preloading element 26.3 has a plurality of contact sections 26.3a, which are of segmental design in the circumferential direction. The contact sections 26.3a are distributed over the circumference, in particular uniformly distributed. Each contact section 28.3f of the holding element 28.3 is assigned a contact section 26.3a. The rotational securing contours 28.3f extend radially inward, starting from the support arm 28.3d. In particular, the rotational securing contours 28.3f extend radially inward beyond the associated support arm 28.3d.

The rotational securing contours 24.3c are formed by a plurality of depressions lined up in the circumferential direction. In cross section, the depressions are of U-shaped design. The rotational securing contours 28.3f of the holding element 28.3 are designed to match the corresponding rotational securing contours 24.3c of the friction disk 24.3.

The base body 28.3a of the holding element 28.3 is formed by a plurality of segments 28.3h, which together correspond to a circular disk, which is interrupted in sections in the circumferential direction. The segments 28.3h together form the toothing 28.3b. Starting from the segments, the support arms first extend in the axial direction and then merge into a radial section of extent. An axial offset is thereby provided between the base body 28.3a and the support arms 28.3d. Accordingly, an intermediate hub disk is eliminated. As a further advantage, centering of the preloading element 26.3 on the intermediate hub 18.3 is thereby made possible during assembly. In particular, the preloading element 26.3 is centered with respect to the radial outer surface of the hub by means of the contact sections 26.3a.

In addition, the support arms 28.3c have lugs 28.3i in the radially outer region, said lugs interacting with recesses 24.3d of the friction disk 24.3. The lugs 28.3i are designed to correspond to the recesses 24.3d by engagement. The lugs and recesses serve as an assembly aid, and therefore the components can be installed by simple insertion during the assembly of the clutch disk or of the torsional damper. In particular, this defines a rotational alignment between the holding element 28.3 and the friction disk 24.3, and therefore the rotational securing contours engage correctly in one another. Optionally, the pairs of lugs and recesses also provide a holding function, thus ensuring that the components cannot fall apart.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A torsional damper, comprising
an input element (E), an output element (A), an elastic element, a friction device,
wherein the input element (E) and the output element (A) are designed to be rotatable to a limited extent with respect to one another against a restoring force of the elastic element,
wherein the friction device has a friction disk, a holding element and a preloading element,
wherein the holding element is connected to the friction disk for conjoint rotation therewith, and
wherein the holding element is connected to the output element (A) for conjoint rotation therewith,
wherein the holding element is arranged axially between the friction disk and the preloading element.

2. The torsional damper as claimed in claim 1, wherein the preloading element is in abutting contact with the friction disk.

3. The torsional damper as claimed in claim 1, wherein the preloading element is designed to provide an axial preload on the friction disk and/or on the holding element.

4. The torsional damper as claimed in claim 1, wherein the holding element is fixedly connected to the friction disk.

5. The torsional damper as claimed in claim 1, wherein the preloading element is in abutting contact with the holding element and provides an axial preload on the friction disk indirectly via the holding element.

6. The torsional damper as claimed in any claim 1, wherein a rotational securing contour is formed on the friction ring, and a rotational securing contour is formed on the holding element, each of said contours corresponding to one another and providing a connection for conjoint rotation under axial preload.

7. The torsional damper as claimed in claim 6, wherein the rotational securing contours on the friction ring and on the holding element are arranged radially on the outside or radially on the inside.

8. The torsional damper as claimed in claim 6, wherein the rotational securing contour on the holding element projects radially outward or radially inward.

9. The torsional damper as claimed in claim 6, wherein the preloading element rests against the rotational securing contour.

10. A clutch disk having a torsional damper as claimed in claim 1.
